(19) United States
(12) Patent Application Publication
(10) Pub. No.: US 2007/0120736 A1
(43) Pub. Date: May 31, 2007

(54) Method and system for discrete location triggering for enhanced asset management and tracking

(75) Inventors: Patricia Denise MacKenzie, Clifton Park, NY (US); Charles Burton Theurer, Clifton Park, NY (US); Brandon Stephen Good, Brainard, NY (US); Jonathan Chan, Provo, UT (US); Douglas Roy Forman, Niskayuna, NY (US); Joseph Edward Jesson, Hamilton Square, NJ (US); Thomas Bernard Breen, Broomall, PA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/289,945

(22) Filed: Nov. 29, 2005

(51) Int. Cl. G01S 5/14; G08B 1/08; G08B 13/14

(52) U.S. Cl. 342/357.07; 342/357.1; 340/539.13; 340/572.1

(57) ABSTRACT

A method and system for discrete location triggering for enhanced asset management and tracking. The system includes an electronic discrete location tracking device affixed to the discrete location and configured to transmit a signal from the discrete location. The system also includes an electronic location trigger processing module to receive and process the signal transmitted by the discrete location tracking device into a location communication signal, wherein the electronic location trigger processing module is affixed to an asset whose discrete location and information are to be managed. The system also includes a remote client computer system operatively connected to the electronic location trigger processing module for exchanging information over a computer network.

### BACKGROUND

The present invention relates generally to systems and methods for managing the flow of physical assets between various entities. More particularly, the present invention relates to methods and systems that utilize various electronic technologies to create and maintain an up-to-date record of location information and asset status, which may then be shared among various personnel.

Traditional location tracking systems as commonly found in prior art either provide global location tracking using global positioning systems (GPS) or discrete location information using radio frequency identification (RFID) or similar technology to obtain real-time data on in-transit locations. These systems typically enable monitoring and management of various inventory systems. Unfortunately however, such real-time systems fail to provide information regarding discrete location specific information such as the delivery and docking status, local events and transactions and physical condition of the delivered goods to customers or interested persons at different global locations. Also, such systems give information either about local status or global location, but not both. Moreover, existing solutions are prohibitively expensive to be implemented, particularly where large numbers of items are included in each shipment and these solutions are not sufficiently broad-based and robust for the real life problems.

Accordingly, there is a need in the art for both global and discrete location triggering system for enabling the tracking of locations and all asset statuses in an automated and cost-effective fashion from its point of shipment to its point of delivery. Additionally, there is a need for a method and system for enabling an integrated solution for a number of specific customer needs, such as: tracking mobile assets through gate-in, gate-out transactions; monitoring yard inventory; and providing visibility into the condition and location of the assets anywhere in the world and making that information available not just locally, but globally.

### BRIEF DESCRIPTION

Briefly, in accordance with one embodiment of the invention, a system is provided for discrete location triggering for global asset management and tracking. The system includes an electronic discrete location tracking device affixed to the discrete location and configured to transmit a signal from the discrete location. The system also includes an electronic location trigger processing module to receive and process the signal transmitted by the discrete location tracking device into a location communication signal to be transmitted globally, wherein the electronic location trigger processing module is affixed to an asset whose discrete location and information are to be managed and tracked globally. The system also includes a remote client computer system operatively connected to the electronic location trigger processing module for exchanging information over a computer network.

In accordance with another embodiment of the invention, a method is provided for discrete location triggering for global asset management and tracking. The method includes transmitting a signal from the discrete location. The method also includes processing the signal into a location communication signal to be transmitted globally, wherein the location communication signal is related to an asset whose discrete location and information are to be managed and tracked globally. The method also includes communicating information related to the asset to a remote client computer system.

### DRAWINGS

These and other features, aspects, and advantages of the present invention will become better understood when the following detailed description is read with reference to the accompanying drawings in which like characters represent like parts throughout the drawings, wherein:

FIG. 1 shows a discrete location triggering system for enhanced asset management and tracking as is explained in accordance with an exemplary embodiment of this invention;

FIG. 2 shows the details of a discrete location triggering system for enhanced asset management and tracking as is explained in accordance with an exemplary embodiment of this invention; and

FIG. 3 shows an exemplary flow chart of a discrete location triggering method as is explained in an exemplary embodiment of this invention.

### DETAILED DESCRIPTION

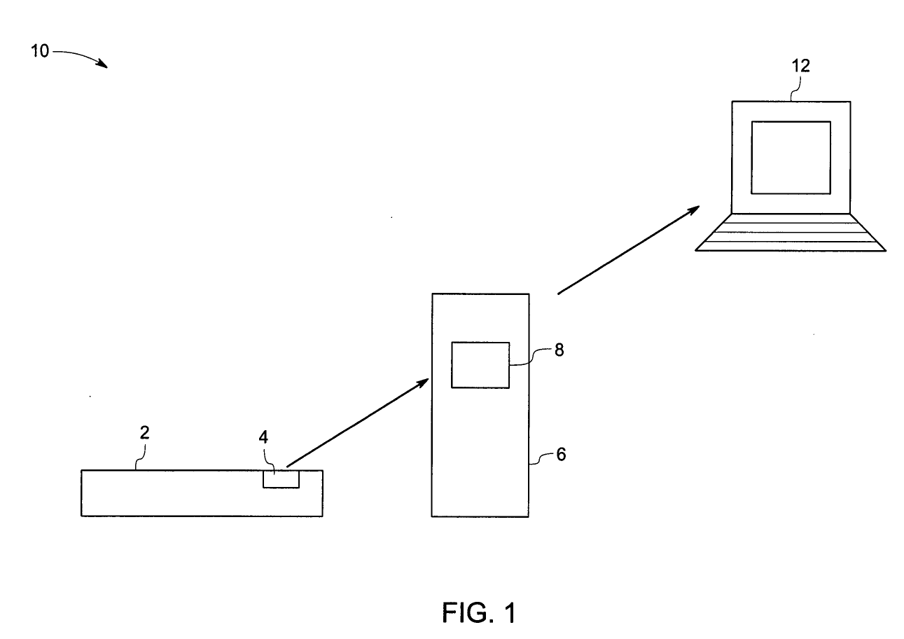

FIG. 1 shows a discrete location triggering system 10 for global asset management and tracking as is explained in accordance with an exemplary embodiment of this invention. In operation, the discrete location triggering system 10 is used to globally track and manage a mobile asset whose discrete location and information are especially important. Referring to FIG. 1, there is a discrete location 2 fitted with an electronic discrete location tracking device 4. The electronic discrete location tracking device 4 generates and transmits a communication signal corresponding to the discrete location 2. The communication signal typically carries identification information relating to the location 2. An asset 6 is fitted with an electronic location trigger processing module 8. The electronic location trigger processing module 8 is configured to receive the communication signal transmitted by the electronic discrete location tracking device 4 and process and transmit the same into a location communication signal. The location communication signal typically combines the location identification information relating to the location 2 with geographical location data relating to the mobile asset 6 and the asset ID and other statuses and information associated with the asset 6.

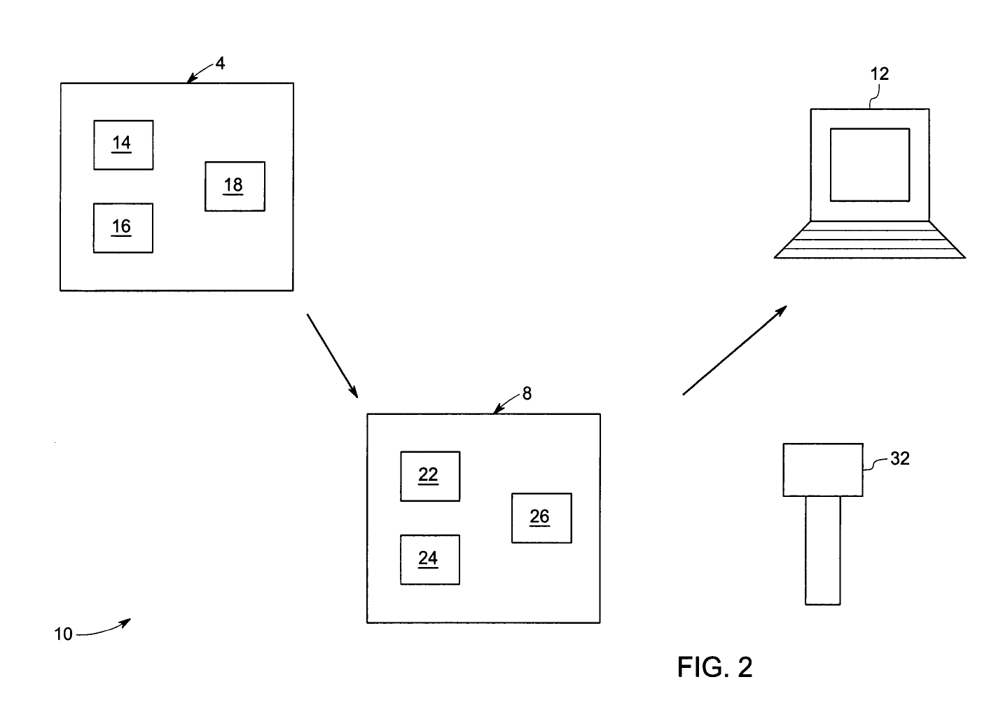

Referring to FIG. 1 again, the discrete location triggering system 10 also includes a remote client computer system 12 that receives the communication signal from the electronic location trigger processing module 6 via a wireless communications network. For instance, remote client computer system 12 may be used to display location triggered information globally, to track delivery and docking status, to track physical condition of the delivered goods to customers or interested persons at different global locations and to track the asset 6 from a point of shipment to its point of delivery. As asset 6 moves from point of shipment to its destination, updates along its route and at site may be recorded automatically and remotely through the use of the discrete location triggering system 10 either with a fixed or a mobile asset or location identification technology such as radio frequency identification technology (RFID). Moreover, in association with these ID's, various status related events such as “at port”, “arrival at site” or the like may be transmitted by a communication transceiver 24 on the asset 6. More details of various subsystems and components of the discrete location triggering system 10 and associated asset or location identification technology is given below in relation to the description of FIG. 2.

FIG. 2 shows the details of the discrete location triggering system 10 for enhanced asset management and tracking of FIG. I as is explained in accordance with an exemplary embodiment of this invention. In addition to the elements described in relation to FIG. 1, the discrete location triggering system 10 also includes an RF emitter 18, an external power supply 14 to RF emitter 18, a battery back-up power supply 16 to RF emitter 18, a RF receiver 22, a communication transceiver 24, a geographical location device 26, and an interrogating device 32. Components in FIG. 2 that are identical to components of FIG. 1 are identified in FIG. 2 using the same reference numerals used in FIG. 1.

Referring to FIG. 2, the electronic discrete location tracking device 4 includes a RF emitter 18 to transmit a communication signal carrying the identification information of the location 2. During implementation of one embodiment of the present system, RFID devices, or tags, are affixed to each location 2 such as various gates, mileposts, signposts, pillars, or the like where activity of the asset is to be tracked. An electronic association is made between each RFID tag and the location 2 where activity is to be tracked. The communication signal is then transmitted in an automated fashion to the RF receiver 22 which is part of the electronic location trigger processing module 8 affixed to the asset 6 as explained in details below.

One element of the present solution is the use of RFID technology enabled electronic asset or location identification devices such as the RF emitter 18 and the RF receiver 22 to track location and status of asset 6 globally. These devices may be programmed prior to use or during use. Such programming may include association of the devices with an electronic identification code, which may be alphanumeric in character. As briefly set forth above, the RF emitter 18 may be used in either a fixed or mobile location 2. Once the RFID emitters are electronically coded with ID's that are associated with location 2 where activity is to be tracked, other associated data such as events, status, and geofencing may also be tracked along with location tracking data. Geofencing is the ability to determine when an asset arrives at or departs from a specific location or enters or leaves a predefined proximity zone around the location. This data when packaged in an organized fashion may be transmitted via the communication transceiver 24.

Although emitter 18 is described only as an emitter, and the receiver 22 is described only as a receiver in the embodiment discussed above, it will be understood that the emitter 18 and receiver 22 can each be part of transceivers capable of both emitting and receiving RF signals. For example, in another embodiment of the invention, the RF receiver 22 may be configured to emit an acknowledgement RF signal back to the RF emitter 18. In another embodiment of the invention, the RF emitter 18 may also be configured to receive any acknowledgement RF signal sent back by the RF receiver 22. Although the terms “emitter 18” and “receiver 22” will be used throughout, those of skill in the art will understand that the use of transceivers to perform these functions does not alter the nature of the system described.

Powering the RF emitter 18 is another aspect of the present technique. As illustrated in FIG. 2, the discrete location tracking device 4 includes a power source 14 to power the RF emitter 18. As the power requirement of the RF emitter 18 is low, the RF emitter 18 may be powered by a battery set 16 to supply back-up power to the RF emitter 18. In one configuration, the RF emitter may have an integrated battery associated with the internal circuitry of the RF emitter 18.

Referring to FIG. 2 again, the RF receiver 22 is configured to receive the signals transmitted by the RF emitter 18. The RF receiver 22 in turn sends the RF signal to the communication transceiver device 24. To enable the end customer/user to maximize the value of its mobile asset fleet, each of the assets 6 is equipped with a geographical location device 26. The communication transceiver device 24 processes the signal transmitted by the RF receiver 22 into a location communication signal and adds the geographical location data from the geographical location device 26. The geographical location device 26 is typically adapted for a variety of mobile assets 6. The geographical location device 26 is designed to meet the critical-to-quality measures by combining geographical location data typically used for global location tracking with signals locally triggered by the RF emitter 18 and received by the RF receiver 22 for location identification of discrete location 2. Although the basic platform remains same as in a typical geographical location device, physical installation methods, power source, antenna design and placement, power management algorithm, and messaging modes are all modified to meet a particular application.

As discussed herein, the communications transceiver may be any of a variety of communications systems that can communicate wirelessly and are capable of connecting to a communications network suitable for communicating globally. These systems can include satellite based communications systems making use of low-earth or geosynchronous satellites, cellular communications systems, wireless Ethernet protocol communications, or such other communications systems that are known in the art. The specific type of communication transceiver chosen does not change the nature of the system provided, as long as the communications transceiver 24 is capable of delivering its message on demand from a variety of locations back to the remote system 12.

Referring to FIG. 2 once more, the geographical location device 26, in one embodiment of the invention may be a Global Positioning System (GPS). However, it is to be understood that a variety of geographical location devices may be used in place of GPS in varying embodiments. The particular choice of geographic location device in any particular embodiment may depend upon the needs of a particular user. Suitable geographical location devices and systems can include, but are not limited to: GPS; devices for cellular tower triangulation; devices for triangulation using wireless Ethernet or other networking devices; Global Location Signaling as commercially available through SkyBitz Corporation; assisted GPS; or such other geographical location systems as are known in the art. While the terms “GPS” and “geographical location device” are used interchangeably in this description, it is understood that the use of other suitable geographical location devices does not alter the nature of the system described here, and these terms should not be construed to require a particular type or model of geographical location device.

In one embodiment of the present invention, for an application where the mobile asset being tracked is a truck trailer, the communication transceiver 24 and a battery pack (not shown) may be mounted together on the nose of the mobile asset 6 between the plywood and an exterior wall, and an antenna (not shown), which mounts on the upper right front panel below the rail. The installation process is designed to be quick and straightforward. For inter-modal units (i.e., containers that are configured for use on multiple types of conveyance, for example, trains, ships and trucks), the location on the asset 6 would be determined in collaboration with the customer. The mounted hardware provides an expandable platform designed to grow with customer business needs. It can be used to provide intelligent battery power management to allow untethered capability for the electronic location trigger processing module 8 (flexible power alternatives are available for many other applications), as well as a rugged, water resistant component housing built to handle the harsh environments a mobile asset 6 may face. The hardware can include numerous sensors, and is expandable so that additional sensors can be added as customer value dictates, and can include a low-profile antenna design.

In operation, the location communication signal is transmitted from the communication transceiver 24 via a satellite-based communications platform. The communication transceiver 24 is typically designed to incorporate a variety of sensor inputs, including the input from the geographical location device 26. Selection of the appropriate sensor inputs is typically based on the specific customer needs such as event tracking, location monitoring, inventory tracking or the like. To fulfill the end customer/user need to monitor gate in/out transactions and other discrete locations, an RF signal coming from the RF emitter 18 and received by the RF receiver 22 is incorporated as a sensor input coming from the discrete location 2 into the communication transceiver 24. This sensor input initiates the communication transceiver 24 to transfer a message, with the location ID and asset ID, whenever the asset 6 passes through given location 2. With the incorporation of the sensor, the communication transceiver 24 acquires the capability of monitoring an asset 6 at discrete location 2 globally as well as locally and transmitting this information to capture discrete events associated with location 2.

In one embodiment of the present invention, where the RF signal is used as a sensor input in the communication transceiver 24, there is no need to deploy a full RFID-based infrastructure, which is normally associated with this technology. Instead, one only needs to install RF trigger emitter 18 at various checkpoint locations. These triggers do not require network connectivity; they can be readily installed at nearly any location or included in a handheld device. Only an external power source 14 needs to be provided to power the RF emitter 18, with battery operation 16 as a backup.

The use of RFID technology, coupled with a geographical location device, offers advantages over traditional implementations in which RFID tags are placed on assets and fixed and/or portable readers are used to read those tags. In such a case, the receivers must be networked, which can be expensive if the locations are far from a hub. As pointed out earlier, the RF trigger emitter 18 needs only to be powered, it does not need to be networked. Since all of the data is transmitted via the communication transceiver 24, there is no need to integrate two different data systems (i.e., geographical location data and RFID data). This simplifies the installation process, and also simplifies reconfiguring the network of monitored locations. In another embodiment of the invention, some additional hardware modifications of the communication transceiver 24 may include environmental enclosures for external applications (e.g., flatbed trailers), installation of the device to a frame unit, and antenna mounting in a discrete and safe location (e.g., on a marker, light, flap, or bumper of a vehicle).

To meet an end customer's need to identify gate in/out transactions for each of its assets 6, the present geographical location device based implementation may offer functionalities beyond simple gate transactions and yard inventory management. It is capable of providing a full global view of the customer's mobile asset 6 anywhere in the world, globally as well as locally. In one embodiment of the invention, as has been pointed out earlier, it is recognized that both geographical location device and RFID need to be leveraged into an integrated system to provide synergistic functionality. In operation, when an asset is moving globally over a long range, the geographical location device may typically play a key role in positioning and tracking the mobile asset. In another instance, while moving inside a dockyard or one such narrow local boundary, the RF trigger emitter 18 and the RF trigger receiver 22 take over to track and position the mobile asset 6.

Various other product features associated with the typical communication transceiver 24 may include relaying information from cargo sensors and door sensors, drop-and-hook notification, geofencing and low-battery notification. The hardware-based features such as cargo sensors enable a fleet to monitor shipments in transit and determine when load status changes between loaded and empty. Door sensors can be used to report location, time and date of a trailer's door opening or closing and can be used with both swing and roll doors. The communication transceiver 24 may also be enabled with a number of software-based features that may be activated remotely. These software-based features may typically include hook/drop notification that enables reporting when a mobile asset 6 is hooked to, or dropped from, a tractor. In a like manner, geofencing allows unlimited geographic boundaries around specific addresses. A mobile asset 6 passing through an assigned boundary generates an event report. Multiple geofences can be assigned to a specific mobile asset 6. In another instance, low battery notification helps customers identify mobile asset 6 that have been sitting idle for extended periods.

In yet another embodiment of the invention, a number of event-based triggers may be implemented in the context of geofencing or in general, such as a door being opened at the wrong location or a mobile asset 6 being dropped at the wrong location. In addition, in a further embodiment of the invention the discrete location triggering system 10 may use geofences to report exceptions to pre-defined detention times at shippers. The key design features of the discrete location triggering system 10 for an asset tracking application is to incorporate a number of event-based triggers to signal when checkpoint events occur, such as confirm gate in/out locations, rail ramp, and at dock and also enable users to inventory specific yards or other locations. The RF emitter 18, located at the checkpoint or location 2, activates the RF receiver 22, which in turn initiates the communication transceiver 24 to send a satellite message, indicating a gate in/out event and providing asset geographical location. The trigger can also send an ID, which indicates the specific checkpoint or location 2 that has been traversed.

Fleets may use a feature of one embodiment of the invention called geofencing to automate the reporting of pre-defined exceptions. Through the network, they can program the coordinates of a landmark, such as a shipper's location, into a mobile asset-mounted tracking unit. When a mobile asset enters or exits the perimeter of an imaginary geofence, a radius around a landmark, the unit automatically sends the date and time it crossed the geofence. The signal can be used to trigger an alarm or to construct a useful report.

A typical customer may use geofencing functionality to trigger a report each time its mobile asset 6 crosses the border across which the asset is moving. The discrete location triggering system 10 may also help the users in tracking turnaround time, system productivity and efficiency when a number of transportation based transactions happen across national or international borders. In one embodiment of the invention, the discrete location being monitored may be a railway yard. In another embodiment of the invention, the discrete location being monitored may be a specific railway track. While GPS or other geographic location devices are applicable for low resolution, to be able to tell the difference between being on one track and another for an asset (such as a railcar), requires higher resolution, and the use of separate discrete locations, one for each track, may be used for this purpose. In yet another embodiment of the invention, the discrete location being monitored may be a typical distribution center of a retail outlet.

In another embodiment of the invention, geofences may be used in combination with other docking events such as dock-in, dock-out status, yard inventory and the like to provide useful information. As mentioned earlier, the RF technology located at various checkpoints and integrated with the geographical location device 26 activates the RF devices, which in turn initiates the communication transceiver 24 to send a message, indicating a gate in/out event and providing asset geographical location. One such implementation of the invention may enable fleets to program multiple geofences into the customers' units and they are notified only when events do not take place according to business rules set up in a web-based system or into a carrier's dispatch system. When a mobile asset 6 equipped with a discrete location triggering system 10 enters (or exits) a geofence, the system can report location-based exceptions, such as a door being opened at the wrong location or a mobile asset 6 being dropped at the wrong location. In addition, the system may be able to use geofences to report exceptions to pre-defined detention times at shippers.

In another embodiment of the invention, in the discrete location triggering system 10, the location communication signal trigger may correspond to a predetermined status related to the discrete location 2. The status may typically include dock-in dock-out status related to the discrete location 2. In another instance, the status may include yard-inventory status related to the discrete location. The planned enhancements to the discrete location triggering system 10 will provide all of the functionality needed to meet customer's needs that may include tracking the asset fleet gate in/out transactions, yard inventory, and visibility into the condition and predetermined status or location of the assets anywhere in the world.

Coupled with geofencing of the yard, the gate in/out transaction can be monitored and verified. In one embodiment of the invention, a handheld device for “on-the-fly” yard inventories could also trigger these events. Referring to FIG. 2, the discrete location triggering system 10 includes one such interrogation device 32 operatively connected to the remote client computer system 12, wherein the interrogation device 32 receives information from the electronic location trigger processing module 8 and exchanges the information with the remote client computer system 12. In one embodiment of the invention, the interrogation device 32 may be configured to trigger RF receiver 22 to communicate with communication transceiver 24 to send out an appropriate message.

In one embodiment of the invention, the interrogation device 32 may be a handheld radio frequency identification trigger reader. In another embodiment of the invention, the handheld radio frequency identification trigger reader may include a handheld computing device. In another embodiment of the invention, the interrogation device 32 may include a handheld computer such as a Palm® Pilot, Compaq iPAQ, Sony Clie, Handspring Visor, Research in Motion Blackberry, or similar device operating on the Windows CE or Palm OS operating systems to transmit and receive radio frequency signals to and from the electronic asset identification devices. Additionally, interrogation device 32 may also include a specialized standalone fixed reading device.

In operation, interaction with site personnel enables up to date information regarding the tracked asset 6 to be easily determined and uploaded to the web application and asset tracking and management based on location triggering database systems for review over the computer network. In particular, once the tracked asset 6 reaches a site, information regarding the asset may be uploaded to the web server 28 by site personnel in a variety of ways, such as direct web entry and handheld synchronization. Initially, a handheld device 32, such as a device running the Windows CE or Palm OS operating systems, is provided with RFID tag reading capabilities, typically by adding both a hardware module and a corresponding software application. Utilizing the handheld device 32 and software application, asset handlers are able to either affirmatively read information from a located asset or locate an asset included within a plurality of tagged assets.

Once the asset is located, additional information regarding the status of the asset may be entered into the handheld device application for future upload to the web application server 28. The entry of this information is simplified by the GUI on the interrogation device 32, which specifically enables input of various information, such as asset receipt, maintenance information, as well as other asset specific and project data.

By providing a handheld device with the capability to receive and synchronize asset and project information from a centralized database on the asset management server 26 and user field entry, the present invention better enables the accurate and up to date exchange of asset management information. Once assets are located and confirmed by users with the handheld device, this information is easily transmitted to the web application server 28 and is subsequently available to the various users in the manner described in detail above. By providing users with the ability to enter information into a remote database on site via the handheld device, the accuracy of this information is substantially improved.

In addition to providing data based upon specified search criteria, one embodiment of the present invention also includes the ability to limit the number of available assets based upon predefined criteria such as: all assets received; all assets not received; all assets confirmed; and all assets not confirmed. By providing this functionality it is even easier for users to directly drill down to the specific asset location they are searching for.

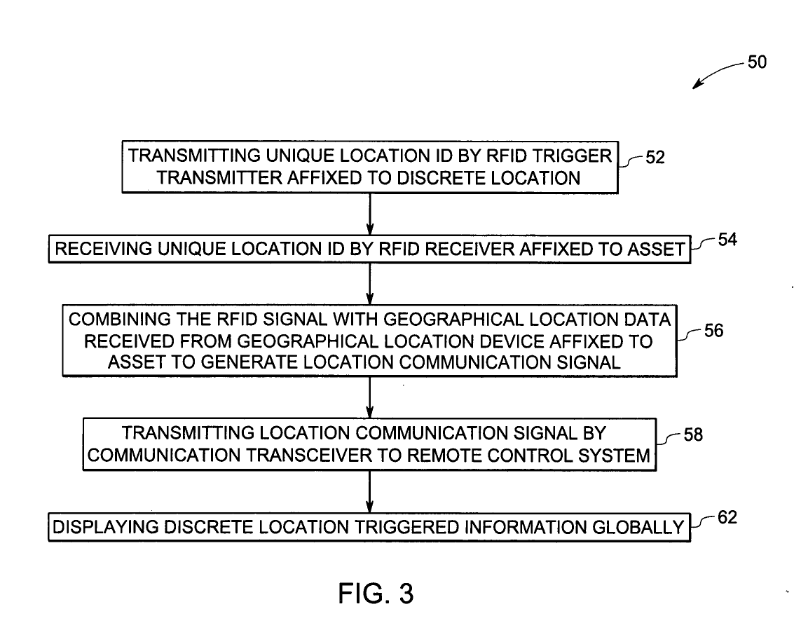

FIG. 3 shows an exemplary flow chart 50 of a discrete location triggering method as is explained in an exemplary embodiment of this invention. The method typically starts with transmitting location id by RFID trigger as in functional block 52. Typically, an electronic discrete location tracking device is affixed to an asset whose location and information are to be managed. At the same time, the discrete location tracking device is programmed to generate and transmit a signal that includes identification information relating to the asset. The location id transmitted by the RFID trigger is received by the RFID receiver as in functional block 54. In the next step, a location communication signal that combines the location id and geographical location data of the asset is generated as in functional block 56. The location communication signal is transmitted to a remote control system as in functional block 58 in the next step. Finally, discrete location triggered information and various events related to discrete location such as gate-in, gate-out transactions, dock-in, dock-out, yard inventory, and visibility is displayed globally as in functional block 62. The method accomplishes automatic global tracking based on location triggers and manual local query and triggering based inventory checking.

Through the present discussion, it should be noted that the present invention may be utilized with various types of asset tracking and management systems deployed on other platforms such as marine containers, refrigerated trailers, flatbeds, automobiles, armored cars, chassis, portable water treatment units and energy-generating units and even mobile medical imaging units. These designs have included customized software, antenna, and power supply options, as well as device form factors.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for discrete location triggering for global asset management and tracking, the system comprising:
an electronic discrete location tracking device affixed to a discrete location and configured to transmit a signal from said discrete location; and
an electronic location trigger processing module having a location receiver and a communications transceiver, the location receiver configured to receive and process said signal transmitted by said discrete location tracking device into a location communication signal, and the communications transceiver configured to transmit the location communication signal globally, wherein said electronic location trigger processing module is affixed to an asset whose discrete location and information are to be managed and tracked globally.

2. The system of claim 1, wherein said discrete location tracking device includes a radio frequency identification trigger emitter to transmit said signal.

3. The system of claim 1, wherein said discrete location tracking device includes a power source to power said radio frequency identification trigger emitter.

4. The system of claim 1, wherein said electronic location trigger processing module includes a radio frequency identification trigger reader to detect said signal transmitted by said electronic discrete location tracking device.

5. The system of claim 1, wherein the electronic location trigger processing module further includes a geographical location device to provide geographical location data corresponding to the position of the asset being tracked, the geographical location device configured to send the geographic location data to the communications transceiver.

6. The system of claim 5, wherein said electronic location trigger processing module device is further configured to include said geographic location data in the location communication signal.

7. The system of claim 1, wherein said location communication signal corresponds to an event related to said discrete location.

8. The system of claim 1, wherein said discrete location comprises an element selected from the group consisting of a railway yard, a railway track, a retail distribution center, and any combination thereof.

9. The system of claim 1, wherein said location communication signal corresponds to at least one element selected from a group consisting of dock-in status, dock-out status, and any combination thereof.

10. The system of claim 1, wherein said signal includes identification information relating to said discrete location.

11. A method for discrete location triggering for global asset management and tracking includes:
transmitting a signal from a discrete location;
receiving said signal on an asset to be tracked;
processing said signal into a location communication signal, wherein said location communication signal includes an identification information related to said discrete location and information identifying the asset; and
transmitting said location communication from the asset via a wireless communications network.

12. The method of claim 11, wherein said transmitting a signal includes:
affixing an electronic discrete location tracking device to a location whose location and information are to be managed; and
programming said discrete location tracking device to generate and transmit said signal that includes identification information relating to said location.

13. The method of claim 12, wherein said discrete location tracking device includes a radio frequency identification trigger emitter.

14. The method of claim 13 also includes powering said radio frequency identification trigger emitter.

15. The method of claim 11, wherein said processing said signal includes:
affixing an electronic location trigger processing module to an asset whose discrete location and information are to be managed;
receiving at said electronic location trigger processing module said signal transmitted by said discrete location tracking device; and
combining said signal received at said electronic location trigger processing module and a geographical location data of said asset to generate said location communication signal.

16. The method of claim 15, wherein said electronic location trigger processing module also includes a radio frequency identification trigger reader, a communication transceiver and a geographical location device.

17. The method of claim 11, wherein said location communication signal corresponds to an event related to said discrete location.

18. The system of claim 17, wherein said discrete location comprises a element selected from the group consisting of a railway yard, a railway track, a retail distribution center, and any combination thereof.

19. The method of claim 17, wherein said event includes an event selected from a group consisting of a gate-in event, a gate-out event, and any combination thereof related to said discrete location and transacted by said asset.

20. The method of claim 11, wherein said location communication signal corresponds to an element selected from a group consisting of dock-in status, dockout status, and any combination thereof.

21. The method of claim 11, wherein said signal includes the identification information relating to said discrete location.
